(19) United States
(12) Patent Application Publication
(10) Pub. No.: US 2013/0259257 A1
(43) Pub. Date: Oct. 3, 2013

(54) CORDED AUDIO DEVICE WITH WIRELESS DATA EXCHANGE

(71) Applicants: Leo Larsen, Kokkedal (DK); Lars Bohn Hansen, Holte (DK)

(72) Inventors: Leo Larsen, Kokkedal (DK); Lars Bohn Hansen, Holte (DK)

(21) Appl. No.: 13/850,676

(22) Filed: Mar. 26, 2013

(30) Foreign Application Priority Data
Mar. 27, 2012 (EP) 12161542

(51) Int. Cl. H04R 3/00

(52) U.S. Cl. CPC H04R 3/00
USPC 381/77

(57) ABSTRACT

Disclosed is a corded audio device comprising a first housing; a first speaker for converting an electronic signal into sound, the first speaker being accommodated in the first housing; a cord with a connector for connection to and receiving an audio signal from a media player, the cord being connected to the first speaker; and a radio unit comprising a radio transmitter for sending control information to the media player, the control information comprising identification data of the audio device.

The present invention relates to a corded audio device adapted for wireless data exchange with a media player or other communication device.

### BACKGROUND

The functionality of communication devices and audio devices, such as headphones and headsets, to be used with communication devices becomes increasingly advanced. Different manufacturers have developed their own connector standards for wired communication necessitating customized audio devices for different communication devices. The many different connector standards are cumbersome for the users and manufacturers.

Wireless audio devices using different wireless communication protocols, such as Bluetooth, are known and require frequent recharging or exchange of batteries.

### SUMMARY

Thus, there is a need for a user-friendly audio device that can be used for different communication devices.

Accordingly, a corded audio device is provided, the audio device comprising a first housing; a first speaker for converting an electronic signal into sound, the first speaker being accommodated in the first housing; a cord with a connector for connection to and receiving an audio signal from a media player, the cord being connected to the first speaker; and a radio unit comprising a radio transmitter for sending control information to the media player. The control information may comprise identification data of the audio device.

The audio device according to the present invention may be used for media players or other communication devices from different manufacturers using different standards for control signals. The combination of a radio unit and a cord enables wireless reading of audio device identifier or other audio device parameters and at the same time allows for use of a simple standard connector for connecting the audio device to a media player or other communication device.

It is an advantage of the present invention that the battery requirements for the audio device may be limited, since only control information is sent wirelessly and audio signals are received and/or sent on a wired connection. Thus a more user-friendly audio device is provided since a user does not have to charge/replace batteries of the audio device on a regular basis.

It is an advantage of the present invention that a media player or other communication device can adapt sound or audio parameters to the audio device based on an audio device identifier (identification data) and/or other control information from the audio device.

It is an advantage of the present invention that the sound quality delivered to a user is not subjected to disadvantages related to radio transmission, such as interference problems.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary audio device according to the invention,

FIG. 2 schematically illustrates an exemplary first housing of an audio device,

FIG. 3 schematically illustrates an exemplary first or second housing of an audio device,

FIG. 4 schematically illustrates an exemplary audio device according to the invention,

FIG. 5 schematically illustrates an exemplary control housing of an audio device,

FIG. 6 schematically illustrates an exemplary control housing of an audio device,

FIG. 7 schematically illustrates an exemplary audio device according to the invention,

FIG. 8 schematically illustrates an exemplary control housing of an audio device,

FIG. 9 schematically illustrates an exemplary first housing of an audio device,

FIG. 10 schematically illustrates an exemplary connector of an audio device,

FIG. 11 schematically illustrates an exemplary connector of an audio device,

FIG. 12 schematically illustrates an exemplary control unit of an audio device, and

FIG. 13 schematically illustrates an exemplary microphone housing of an audio device.

### DETAILED DESCRIPTION

The figures are schematic and simplified for clarity, and they merely show details which are essential to the understanding of the invention, while other details may have been left out. Throughout, the same reference numerals are used for identical or corresponding parts.

The audio device may be headphones, earphones, speakerphones (conferencing devices) or a headset.

The media player may be a music or film player, mobile phone, a smart phone with or without a touch screen, or a tablet computer.

The audio device comprises a first housing and a first speaker or first speakers for converting an electronic signal into sound. The first speaker may be accommodated in the first housing. The first housing may accommodate a single first speaker or a plurality of first speakers, e.g. including a first primary speaker and a first secondary speaker.

Further, the audio device comprises a cord with a connector, e.g. for connection to and receiving an audio signal from a media player. The cord may comprise a primary part with a first end and a second end. The connector may be attached to the cord at the first end of the primary part. The cord may comprise one or more secondary parts, e.g. a first secondary part and/or a second secondary part, each having a first end and a second end. The cord may comprise a number of wires including a first wire and a second wire connecting one or more terminals of the connector to different parts of the audio device. The cord or parts thereof may be connected to the first speaker(s). The audio signal may be analog or digital. An analog audio signal from the media player may be fed directly to the first speaker(s) or a first speaker unit optionally including a filter unit. In one or more embodiments, an analog or digital audio signal from the media player may be fed to a first processing unit a common processing unit between the connector and the first speaker(s). The cord may comprise at least one or a plurality of wires connected to respective terminals of the connector. The cord may comprise a first wire connected to a first connector terminal and/or a second wire connected to a second connector terminal. The number of wires and terminals may be limited, e.g. the cord may comprise less than 5 wires. The number N of wires in the cord may be in the range from 1 to 4, e.g. N=2 or N=3, or N=4.

The audio device comprises a radio unit comprising a radio transmitter for sending control information to the media player. Optionally, the control information comprises identification data of the audio device. The identification data of the audio device may comprise one or more of speaker performance data, e.g. speaker frequency response and/or speaker impedance, model number data, user interface data, and speaker sensitivity data. The media player may then be configured for selecting one or more audio signal parameters of the audio signal based on the identification data of the audio device.

The audio device may comprise a control unit incorporating the radio unit. For example, a control unit may comprise a printed circuit board (PCB) with the radio unit mounted thereon. The radio unit may comprise or be constituted by a Bluetooth chip, such as a Blutooth Low Energy (BLE) Chip. The control unit may comprise one or more of at least one clock generator, an antenna and a memory. The antenna may be incorporated in the radio unit. The memory may store identification data of the audio device. The audio device may comprise first battery terminals connected to the radio unit, e.g. for feeding the radio unit and/or control unit. A first battery may be connected to or attached to the first battery terminals.

The audio device may comprise a user interface enabling a user to provide user input to the audio device. The user interface may comprise one or more buttons, e.g. including a first button and optionally a second button. In one or more embodiments, the user interface has between two and ten buttons. The user interface may be connected to one or more input terminals of a control unit, e.g. directly to one or more input terminals of the radio unit or a BLE chip. The user interface may comprise a microphone and a voice command detection unit adapted for receiving and processing voice commands for voice control of the audio device. The user interface may comprise a connect button, where the audio device is adapted to send identification data of the audio device upon activation of the connect button.

The audio device may be adapted to send control information to the media player based on the user input from the user interface. For example, the radio unit may be adapted to send a first control signal when a first button of the user interface is activated or pressed. The radio unit may comprise one or more antennas. Upon activation of different buttons of the userface, the audio device may be adapted to send different control signals to the media player, e.g. enabling a user to control the media player and operation thereof. The radio unit unit may be adapted for Bluetooth communication, e.g. according to the Bluetooth Low Energy (BLE) protocol.

The audio device may comprise a control housing attached to the cord, wherein the user interface and/or the radio unit is/are arranged in the control housing. A control housing with user interface and radio unit attached to the cord may improve user friendliness of the audio device by facilitating user input during use. The control housing may be positioned at a distance from the first housing along the cord. The distance between the first housing and the control housing along the cord may be at least 5 cm, such as in the range from 5 cm to about 80 cm.

The user interface and/or the radio unit may be arranged in the connector. A user interface and radio unit arranged in the connector may improve user friendliness of the audio device by facilitating user input during use.

The user interface and/or the radio unit may be arranged in the first housing. A user interface and radio unit arranged in the first housing may provide a simple audio device with few complex parts, e.g. by incorporating movable parts into few or a single housing. This may lead to reduced assembly costs.

There may be a need for controlling the audio device from the media player thereby improving the overall user experience. The radio unit may comprise a radio receiver for receiving control information from the media player.

The control information to the media player may comprise control data or different control signals for the media player, e.g. control data or control signals indicative of one or more of the following: “VOLUME UP”, “VOLUME DOWN”, “CONNECT”, “DISCONNECT”, “NEXT”, “PREVIOUS”, “PLAY/PAUSE”, “STOP”.

The audio device may comprise one or more battery compartments for accommodating one or more batteries for delivering power to the audio device. The audio device may comprise a set of battery charge terminals for allowing recharging of at least a first battery and/or a second battery.

The audio device may comprise a second housing and a second speaker or second speakers for converting an electronic signal into sound. The second speaker(s) may be accommodated in the second housing. The second may accommodate a single second speaker or a plurality of second speakers, e.g. including a second primary speaker and a second secondary speaker.

The cord may be connected to the second speaker(s). An analog audio signal from the media player may be fed directly to the second speaker(s) or a second speaker unit optionally including a filter unit. In one or more embodiments, an analog or digital audio signal from the media player may be fed to a second processing unit or to the common processing unit between the connector and the second speaker(s). The audio device may comprise second battery terminals, e.g. connected to processing unit, e.g. the first processing unit and/or the second processing unit. Second battery terminals may be connected to the common processing unit.

The connector may be a two-terminal connector, a three-terminal connector, or a four-terminal connector. Accordingly, the number of terminals is relatively low, reducing the complexity of the connector.

The audio device may be adapted for two-way audio communication. Accordingly, the audio device may comprise a microphone and the wherein the audio device may be configured for bi-directional or two-way audio communication via the cord.

It may be desirable to reduce the number of required user input or user operations during setup or connecting the audio device. At the same time, it is desired to send identification data with as large time interval as possible in order to save power. Accordingly, the audio device may be adapted to detect connection status of the connector, i.e. whether the connector is plugged into a media player or not, and send control information to the media player via the radio unit based on the connection status. The audio device may thus comprise a detector unit for detecting connection status and adapted for activating the radio unit by triggering sending of identification data. In one or more embodiments, the radio unit is disabled when the connector is not connected as by the detector unit.

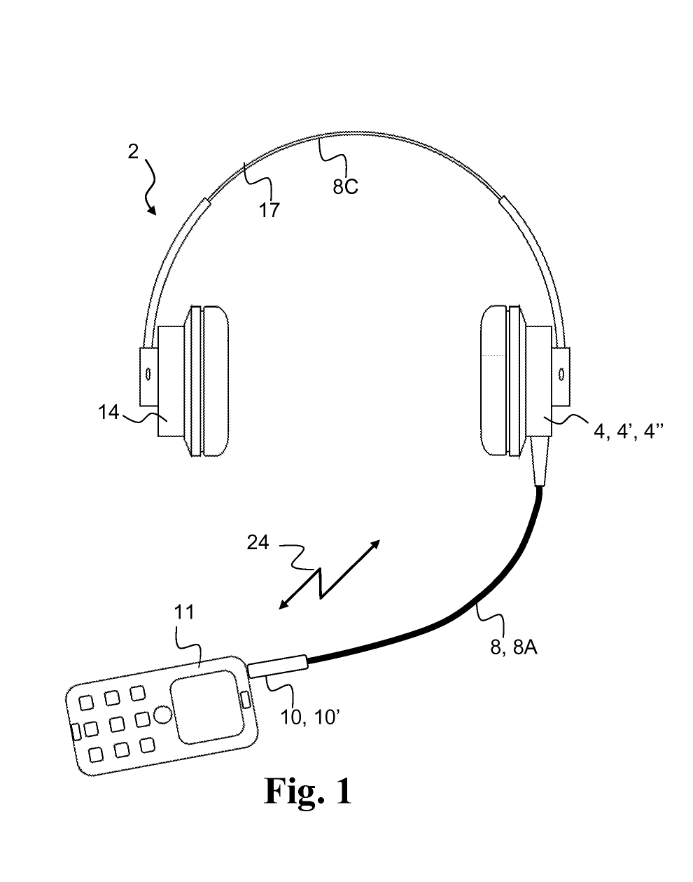

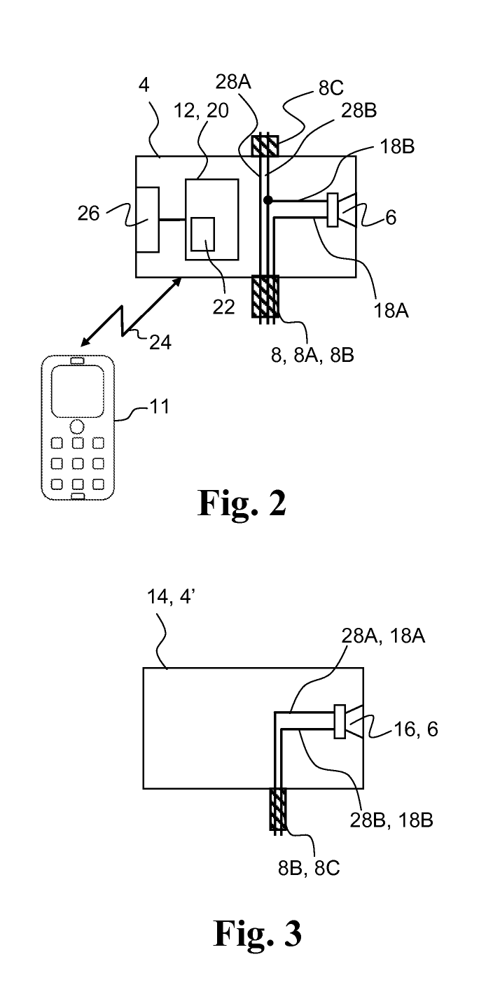

FIG. 1 schematically shows an audio device according to the present invention. The audio device 2 comprises a first housing 4, a first speaker 6 for converting an electronic signal into sound, the first speaker 6 being accommodated in the first housing 4 as seen in FIG. 2. The audio device 2 has a cord 8 with a primary part 8A having a first end with a connector 10 for connection to and receiving an audio signal from a media player 11, the cord 8 being connected to the first speaker 6. Further, the audio device 2 comprises a radio unit 12 comprising a radio transmitter for sending control information to the media player 11 on a wireless connection 24, the control information comprising identification data of the audio device 2. In the audio device in FIG. 1, the radio unit 12 is accommodated in the first housing 4 as seen in FIG. 2. Optionally, the audio device 2 comprises a second housing 14 accommodating a second speaker 16 as seen in FIG. 3 connected to the connector 10 via cord 8. The audio device may comprise a connecting band or device 17, such as a head band or neck band, connecting the first housing 4 and the second housing 14. A second secondary part part 8C may connect the second speaker 16 to the primary part 8A.

FIG. 2 schematically illustrates an exemplary first housing 4 accommodating a first speaker 6. The first speaker 6 is connected to a first wire 18A and a second wire 18B of the primary part 8A of the cord 8. The wires 18A and 18B are connected to respective first and second terminals of the connector 10 for receiving an audio signal from a media player. The radio unit 12 or a control unit 20 comprising the radio unit 12 is accommodated in the first housing 4. The radio unit 12 and/or the control unit 20 comprises a radio transmitter 22 for sending control information to the media player over a wireless connection 24. Further, a user interface 26, e.g. comprising one or more push buttons, is connected to the radio unit 12 and/or control unit 20 thereby enabling a user to control the radio unit, e.g. by activating a first push button which will trigger sending identification data to the media player 11. In an audio device 2 with a first housing 4, the second housing 14 with the second speaker 16, the third wire 28A and the fourth wire 28B, and the second secondary part 8C may be omitted and the connector 10 may be a two-terminal connector. The connecting band 17 may be omitted for an audio device 2 where the first housing 4 and/or the second housing 14 are adapted for at least partly insertion into the ear canal. In an audio device 2, the second housing 14, the second secondary part 8C, the third wire 28A and the fourth wire 28B may be omitted and the connector 10 may be a two-terminal connector.

FIG. 3 illustrates an exemplary housing for use in the audio device, e.g. first housing 4 and/or second housing 14 accomodating a speaker 6, 16, respectively. The second speaker 16 may be connected to respective second and third terminals of the connector 10 for receiving an audio signal from a media player via third wire 28A and fourth wire 28B, respectively. The fourth wire 28B may be connected to the second wire 18B. Accordingly, the cord 8 may be a three-wire cord with a first wire 18A connected to a first terminal of the connector 10 and third wire 28A connected to a third terminal of the connector, the first and third wire acting as signal wires, the cord further comprising a common ground wire (second wire 18B) connected to a second terminal of the connector.

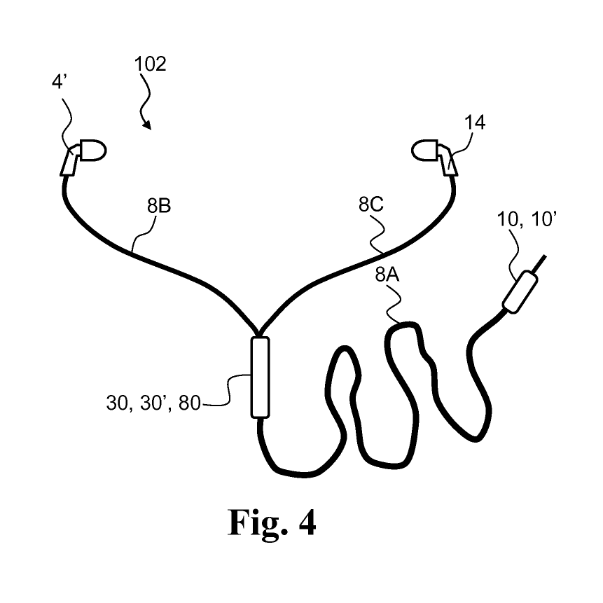

FIG. 4 illustrates an exemplary audio device 102, e.g. of the earphone type. The audio device 102 comprises a first housing 4′ and a second housing 14, e.g. as illustrated in FIG. 3. The first housing 4′ and the second housing 14 are in the audio device 102 shaped for at least partly insertion into the ear canal of a user. The primary part 8A and the first secondary part 8B connect the first speaker 6 to a first terminal and a second terminal of the connector 10. The primary part 8A and the second secondary part 8C connects the second speaker 16 to a second and third terminal of the connector 10. A control housing 30 is attached to the cord. The distance between the first housing 4′ and the control housing 30 along the cord, i.e. along the first secondary part 8B is about 20 cm.

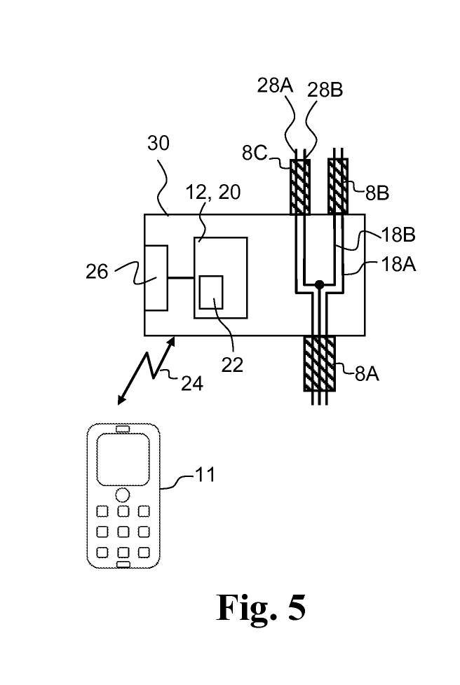

FIG. 5 shows an exemplary control housing 30, e.g. of the audio device 102 in FIG. 4. The control housing 30 accomodates the radio unit 12 and/or control unit 20. A user interface 26 is also accomodated in the control housing 30′. The fourth wire 28B is connected to the second wire 18B in the control housing and the primary part 8A has three wires connected to respective first, second and third terminals of the connector 10 which here is three-terminal connector. In an audio device 102 with a control housing 30, the second housing 14, the second secondary part 8C, the third wire 28A and the fourth wire 28B may be omitted and the connector 10 may be a two-terminal connector.

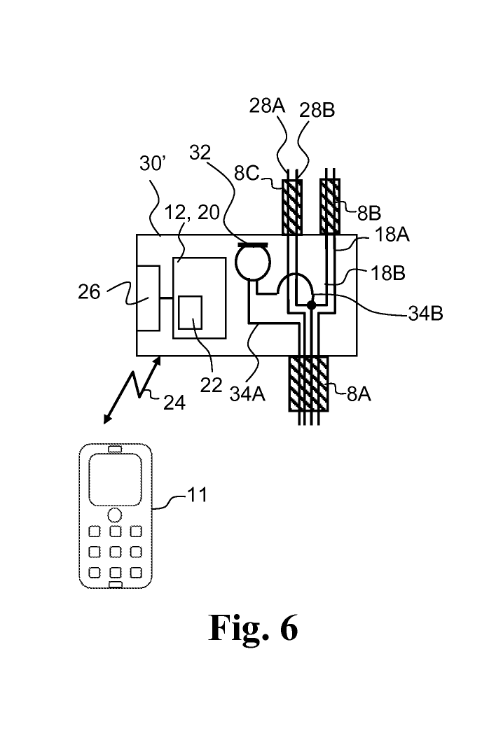

FIG. 6 shows an exemplary control housing 30′, e.g. of the audio device 102 in FIG. 4. The control housing 30′ is similar to the control housing 30 in FIG. 5 and additionally comprises a microphone 32 connected to a fifh wire 34A and a sixth wire 34B. The fifth wire 34A forms a part of the primary part 8A and is connected to a fourth terminal of the connector 10 which here is four-terminal connector. The audio device 102 with the control housing 30′ is adapted for bi-directional audio communication via the primary part 8A of the cord 8. In an audio device 102 with a control housing 30′, the second housing 14, the second secondary part 8C, the third wire 28A and the fourth wire 28B may be omitted and the connector 10 may be a three-terminal connector.

The audio device may comprise a microphone that is mounted on a microphone arm attached, e.g. movably attached, to the first housing. The sixth wire may be connected to the second wire in the first housing. A microphone may be accommodated in the first housing or the second housing for bi-directional audio communication via the primary part of the cord.

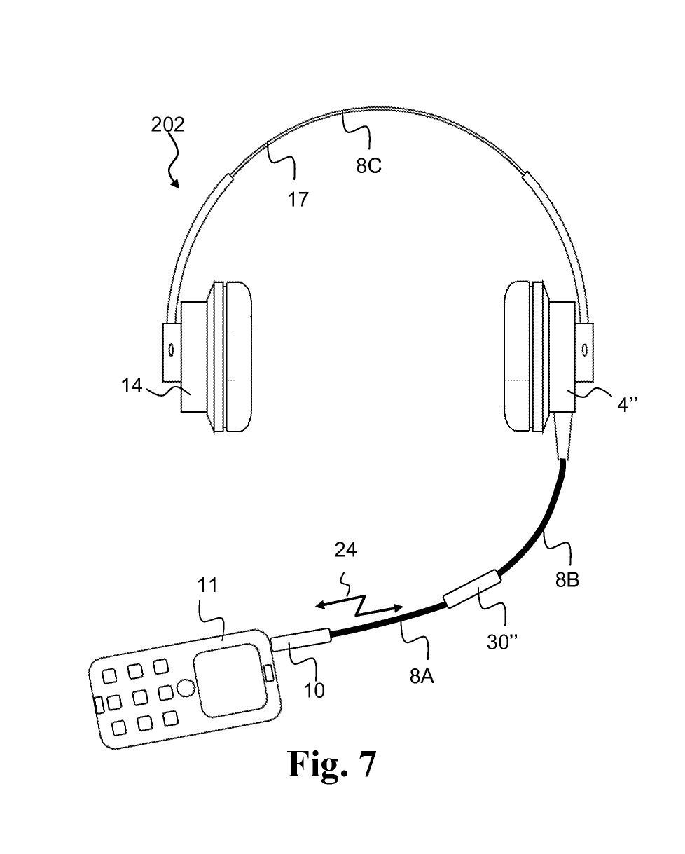

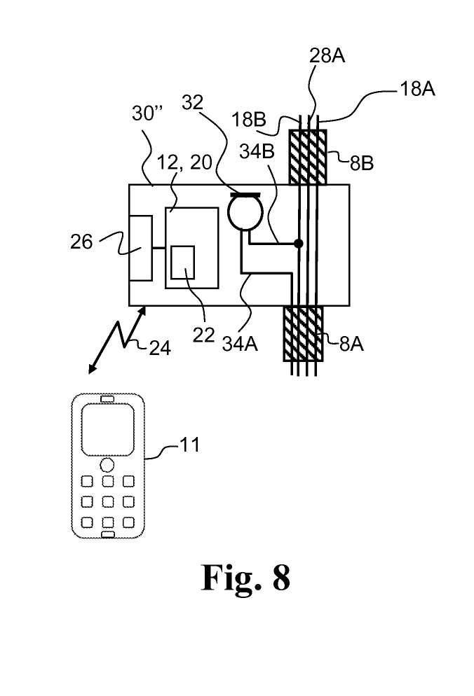

FIG. 7 illustrates an exemplary audio device according to the invention. The audio device 202 comprises a first housing 4″, a second housing 14, a cord comprising a primary part 8A, a first secondary part 8B, and a second secondary part 8C. The primary part 8A has a first end with a connector 10 for connection to and receiving an audio signal from a media player 11. The audio device 202 comprises a control housing 30″, e.g. as illustrated in FIG. 8 for sending wireless control information to the media player.

FIG. 8 illustrates an exemplary control housing of an audio device. The control housing 30″ accommodates a radio unit 12 and a user interface 26 for sending control information to a media player. Further, the control housing 30″ accommodates a microphone 32 for bi-directional audio communication via the primay part 8A of the cord.

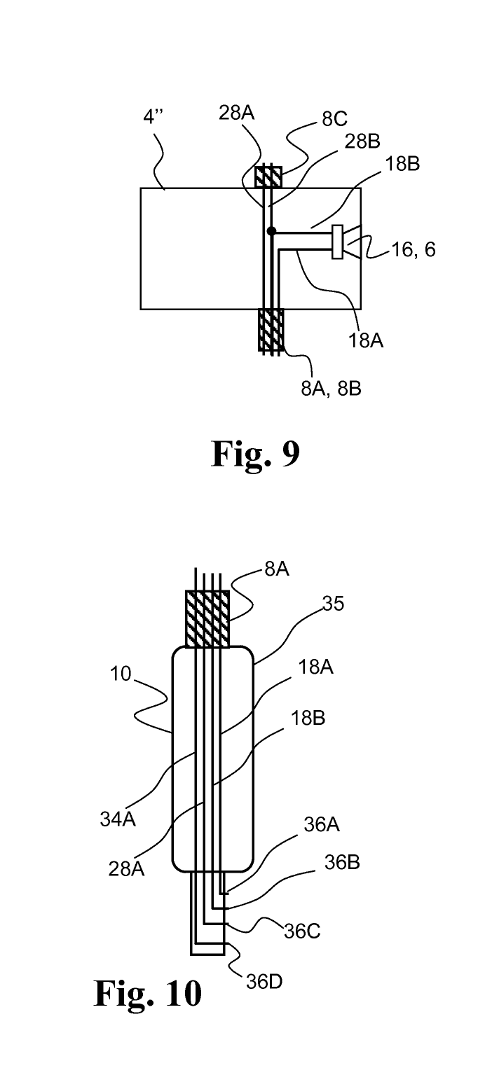

FIG. 9 schematically illustrates an exemplary first housing of an audio device. A second secondary part 8C of the cord connects the first housing 4″ to a second housing 14. The fourth wire 28B is connected to the second wire 18B in the first housing 4″.

FIG. 10 schematically illustrates an exemplary connector of an audio device. The connector 10 is a four-terminal connector, e.g. a TRRS (tip, ring, ring, sleeve). connector, and comprises a connector housing 35. The connector has a first terminal 36A connected to first wire 18A of the primary part 8A of the cord for connection to respective terminal of connector in a media player. Further, the connector has a second terminal 36B connected to second wire 18B, a third terminal 36C connected to third wire 28A and optionally a fourth terminal 36d connected to a fifth wire 34A. The number of terminals and wires in the connector and the primary part of the cord depends on the desired functionality and number of different parts of the audio device. From a connection quality perspective, it may be desirable to keep the number of terminals to four or less. The connector 10 may be a TRS connector (tip, ring, sleeve). It is cylindrical in shape, typically with three contacts or terminals, although sometimes with two (a TS connector) or four (a TRRS connector). The connector may be an audio jack, phone jack, phone plug, and jack plug. Specific models may be termed stereo plug, mini-jack, mini-stereo, headphone jack, tiny telephone connector and bantam plug. The male part of the connector may have a diameter of 3.5 mm or 2.5 mm.

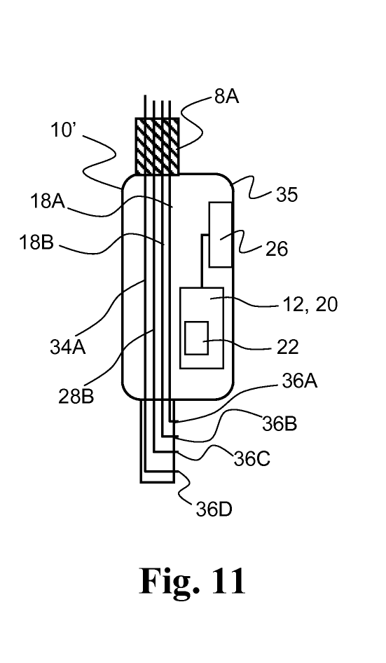

FIG. 11 schematically illustrates an exemplary connector of an audio device. The connector 10′ comprises a connector housing 35 accommodating a radio unit 12 and a user interface 26 for sending control information to a media player. One or more embodiments of the audio device may comprise the first housing 4″ and connector 10′.

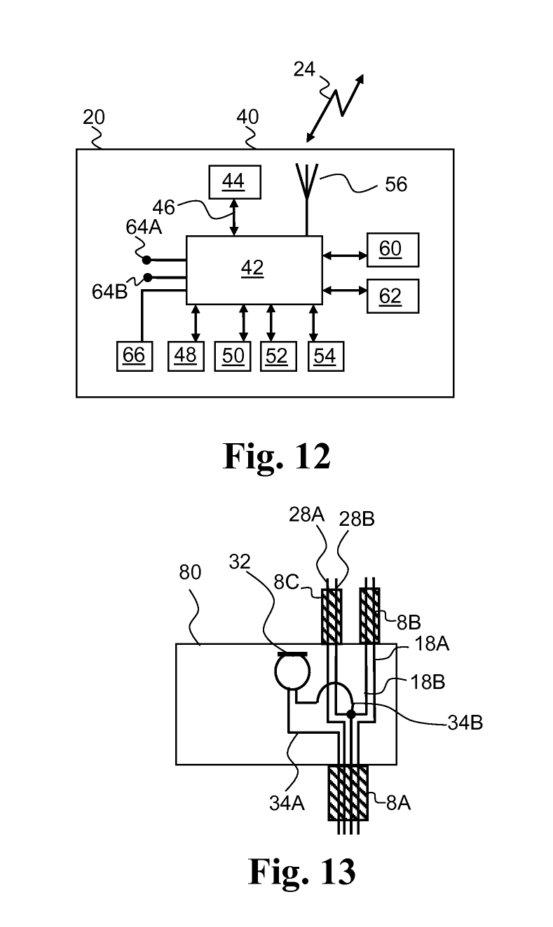

FIG. 12 schematically illustrates a control unit 20. The control unit comprises a printed circuit board (PCB) 40 comprising wires for connecting different parts of the control unit. The control unit 20 comprises a radio unit 12 with a radio transmitter in form of a bluetooth low energy (BLE) chip 42 and an antenna 56 mounted on the PCB 40. Further, the control unit 20 comprises a memory unit 44 connected to the BLE chip 42 via connection 46 comprising the necessary number of wires. The control unit comprises a number of switches 48, 50, 52, 54 connected to the BLE chip and forming a part of the user interface 26 thereby enabling a user to provide input to the BLE chip by activating the switches. The number of switches may be adapted to the desired number of input buttons. The antenna 56 is connected to the BLE chip in order to send radio signals to a media player. The control unit 20 also comprises a first clock unit 60 operating at a first frequency f₁ (e.g. about 8 MHz or about 16 MHz) and optionally a second clock unit 62 operating at a second frequency f₂ (e.g. in the range from 10-40 KHz, such as about 32.8 KHz). The second clock unit 62 may be replaced by a downclocking circuit (not shown). The control circuit 20 may further comprise a first battery terminal 64A and a second battery terminal 64B for connection of a battery.

Optionally, the control circuit comprises a detector unit 66 connected to the BLE chip. The detector circuit may be adapted to detect whether the audio device is connected or not (connection status). The BLE chip 42 may be adapted to send control information to the media player via the antenna based on the connection status of the audio device. A magnetic detection principle may be applied in the detector unit 66, e.g. by detecting signal activity between two wires in the audio device, e.g. the first wire and the second wire.

FIG. 13 discloses a microphone housing for an audio device according to the invention, e.g. an audio device comprising a connector 10′. The microphone housing 80 is attached, mounted to or molded around the cord. The distance between the first housing and the microphone housing 80 along the cord, i.e. along the first secondary part 8B is in the range from 5 cm to about 40 cm, e.g. about 10 cm, about 15 cm or about 20 cm.

It should be noted that in addition to the exemplary embodiments of the invention shown in the accompanying drawings, the invention may be embodied in different forms and should not be construed as limited to the embodiments set forth herein. Rather, these embodiments are provided so that this disclosure will be thorough and complete, and will fully convey the concept of the invention to those skilled in the art.

### LIST OF REFERENCES

2, 102, 202 Audio device

4, 4′, 4″ First housing

6 First speaker

8 Cord

8A Primary part

8B First secondary part

8C Second secondary part

10 Connector

11 Media player

12 Radio unit

14 Second housing

16 Second speaker

18A First wire

18B Second wire

20 Control unit 20

22 Radio transmitter

24 Wireless connection

26 User interface

28A Third wire

28B Fourth wire

30, 30′, 30″ Control housing

32 Microphone

34A Fifth wire

34B Sixth wire

35 Connector housing

36A First terminal, First connector terminal

36B Second terminal, Second connector terminal

36C Third terminal, Third connector terminal

36D Fourth terminal, Fourth connector terminal

40 PCB

42 BLE chip

44 Memory unit

46 Connection

48 First switch

50 Second switch

52 Third switch

54 Fourth switch

56 Antenna

60 First clock unit

62 Second clock unit

64A First battery terminal

64B Second battery terminal

66 Detector unit

80 Microphone housing

1. A corded audio device comprising
a first housing;
a first speaker for converting an electronic signal into sound, the first speaker being accommodated in the first housing;
a cord with a connector for connection to and receiving an audio signal from a media player, the cord being connected to the first speaker; and
a radio unit comprising a radio transmitter for sending control information to the media player, the control information comprising identification data of the audio device and wherein the audio device includes a user interface enabling a user to provide user input to the audio device and is adapted to send control information to the media player based on the user input from the user interface.

2. (canceled)

3. (canceled)

4. Audio device according to claim 1, comprising a control housing attached to the cord, wherein the user interface and/or the radio unit is/are arranged in the control housing.

5. Audio device according to claim 1, wherein the user interface and/or the radio unit is/are arranged in the connector.

6. Audio device according to claim 1, wherein the user interface and/or the radio unit is/are arranged in the first housing.

7. Audio device according to claim 1, wherein the radio unit comprises a radio receiver for receiving control information from the media player.

8. Audio device according to claim 1, wherein the identification data of the audio device comprises one or more of speaker performance data, model number data, user interface data, and speaker sensitivity data.

9. Audio device according to claim 1, wherein the control information to the media player comprises control data for the media player.

10. Audio device according to claim 1, comprising a battery compartment for accommodating a battery for delivering power to the audio device.

11. Audio device according to claim 1, comprising a second housing and a second speaker for converting an electronic signal into sound, the second speaker being accommodated in the second housing and connected to the cord.

12. Audio device according to claim 1, wherein the connector is a two-terminal connector, a three-terminal connector, or a four-terminal connector.

13. Audio device according to claim 1, comprising a microphone and wherein the audio device is configured for bi-directional audio communication via the cord.

14. Audio device according to claim 1, wherein the radio unit is adapted for Bluetooth communication, e.g. according to the Bluetooth Low Energy (BLE) protocol.

15. A corded audio device comprising
a first housing;
a first speaker for converting an electronic signal into sound, the first speaker being accommodated in the first housing;
a cord with a connector for connection to and receiving an audio signal from a media player, the cord being connected to the first speaker; and
a radio unit comprising a radio transmitter for sending control information to the media player, the control information comprising identification data of the audio device and wherein the audio device is adapted to detect connection status of the connector and send control information to the media player via the radio unit based on the connection status.
